(19) United States
(12) Patent Application Publication
(10) Pub. No.: US 2011/0220234 A1
(43) Pub. Date: Sep. 15, 2011

(54) APPARATUS FOR TAKING IN POWDER MATERIAL AND GRANULES AND CAPSULE THEREFOR

(76) Inventor: Rouven Haas, Wien (AT)

(21) Appl. No.: 12/998,739

(22) PCT Filed: Nov. 25, 2009
(86) PCT No.: PCT/AT2009/000461

§ 371 Date: Jun. 1, 2011

(30) Foreign Application Priority Data
Nov. 26, 2008 (AT) A 1847/2008
Dec. 22, 2008 (AT) A 1998/2008
Jun. 25, 2009 (AT) A 987/2009

(51) Int. Cl. F16L 9/00; B65D 17/42

(52) U.S. Cl. 138/109; 220/277

(57) ABSTRACT

The invention relates to an apparatus (1) for taking in powder material or granules (2) from a capsule (3), having a suction tube body (4, 25) which comprises a suction channel (7) and a suction end (6), and a capsule holder disposed opposite of the suction end (6), and a capsule attachment device (9), wherein a capsule attachment tip (10) designed for attaching the capsule (3) on only one side transitions into the suction tube body (4, 25) by way of a shaft (8), wherein in the shaft (8) at least one hole (11) extending radially to the longitudinal axis of the shaft (8) is provided, on which the suction channel (7) in the suction tube body (4) adjoins, and wherein the shaft (8), which during attachment of a capsule (3) rests on the inside thereof, forms the capsule holder.

The invention relates to an apparatus for taking in powder materials or granules from a capsule, having a suction tube body which comprises a suction channel and a suction end, and a capsule holder disposed at the suction tube body opposite of the suction end, and a capsule piercing device.

Such an apparatus is known from DE 10 2005 043 449 B3. A similar apparatus is disclosed in DE 30 16 127 A. These known apparatuses are provided for the inhalation of a powder released from a capsule having perforations at both ends. The apparatus comprises two housing parts jointly confining a capsule holder, and one of them forming a suction tube body with a suction channel. The two housing parts are provided with capsule piercing pins that are e.g. designed in the form of pyramids with a triangular base area so as to achieve an improved perforation of the capsules by an accurate cutting, or in the form of hollow needles, respectively. However, the relatively high effort of manufacturing and also of handling these known apparatuses is of disadvantage since the two housing parts have to be separated from each other for the insertion of a capsule and have to be joined again once the capsule has been inserted, wherein the capsule is pierced at both front sides by means of the pins described. The housing part facing away from the suction tube body provides an air suction portion for inhalation, so that this air suction portion enables the sucking of air into and through the capsule so as to entrain particles contained therein. In accordance with an embodiment of the apparatus pursuant to DE 30 16 127 A, only one needle is provided for the piercing of the capsule, but the needle is long enough to pierce the inserted capsule at both ends when the two telescopic parts of the apparatus are pushed together. Similar apparatuses with a long needle or two opposing needles are illustrated in WO 2007/106397 A2. Here, too, the respective capsule is pierced at both ends. Furthermore, the capsule holder is here also provided inside a multi-part housing, i.e. the capsule is always inserted in a cavity in the housing.

U.S. Pat. No. 5,287,850 A further discloses an elaborately designed inhalation apparatus for the time and velocity-controlled dispensing of drugs in powder form, wherein the interior of a capsule is impacted with excess pressure to make it burst. In this context, there is also provided a tube connected with a piercing needle, said tube having associated a valve.

GB 2 253 200 A illustrates a breakable capsule provided to be used in an inhalation apparatus, wherein the breaking of the capsule is to be performed as easily as possible so as to release the drug contained in the capsule. The capsule is designed relatively elaborately with a grid insert for the retaining of capsule pieces.

AT 504 991 A1 describes an apparatus for the oral taking of foods or enjoyment foods, wherein the particle-shaped material to be taken is to have a particular maximum size or minimum size, respectively, so as to avoid the formation of an aerosol penetrating the airways, on the one hand, and to avoid too large particles that would not adhere to the buccal mucosa, on the other hand. In this known apparatus there is provided a particle material reservoir that may be a part of the apparatus itself, and that comprises again openings at both sides in order to suck the particle material from the reservoir and to be able to direct it to the buccal mucosa. This known apparatus is also relatively elaborate in its design and frequently not very easy to handle, either.

It is an object of the invention to provide an apparatus as indicated initially, enabling easy manufacturing and handling. In particular, this apparatus is intended to be used like a tobacco product, wherein, similar to a cigarette or a cigar, the suction tube body is sucked on so as to take in particle material from a per se usual capsule provided at the suction tube body.

For solution of the object posed, the invention provides an apparatus for taking in powder material or granules from a capsule as defined in claim 1. Advantageous embodiments and further developments are indicated in the dependent claims.

During use of the present invention, the respective capsule is pierced at one side only while it remains attached to the tip, or shaft, respectively. The invention makes use of the finding that air may flow into the capsule directly at the capsule breakpoint where the tip penetrated into the capsule, once the suction tube body is sucked on, wherein the air flowing into the capsule flows, along with the particle material swirled therein, out of the capsule through the hole into the suction channel of the suction tube body so as to be supplied to the mouth. Only one radially or transversely extending hole may be provided in the shaft, but as a matter of fact there may also be provided several radial holes, e.g. two, three, or four such holes, wherein the holes may be positioned to be diametrically opposite from each other. The tip may be conical, wherein the vertex angle of the cone is chosen as a function of the material of the capsule wall to be pierced. The vertex angle, for instance, ranges between 20° and 90°, wherein it is the smaller, the rougher the material is, whereas it is the larger, the softer the material of the capsule wall is. The capsule wall consists, for instance, of gelatine or cellulose material, and tests have shown that with a corresponding measurement there always remains a sufficiently broad gap between the shaft of the apparatus and the edge of the opening produced in the capsule for having air flown in there. By the fact that the air flows into the capsule in a kind of counterflow once the suction tube body is sucked on, the particle material in the interior of the capsule is swirled intensively, so that a safe entrainment of this particle material in the air flow to the mouth is given.

The suction tube body along with the shaft and the tip may be manufactured integrally, for instance, of a biopolymer, e.g. of PLA, CAP, etc. The capsule itself, which is held frictionally on the shaft after piercing, may also be arranged to be inclined to the functional part, i.e. to the suction tube body, without the function being impaired. The capsule content is preferably dimensioned such that the particle material is taken in orally during sucking, approximately comparable with the smoking of a cigarette, in about 5 min to 10 min. If the production of an aerosol is undesired, the particle size should at least be 30 μm, and preferably it is maximally 150 μm. The particle material may be water-soluble, may be microscopic, and may comprise, for instance, 60 percent of effervescent powder, so that an absorption in the buccal mucosa is easily possible. An agent such as caffeine may also be added to the particle material. It is, however, theoretically also possible to use the present apparatus for the inhalation of an aerosol drug for the treatment of the bronchia or the lungs, wherein the size of the particle material might then be e.g. approximately 2.5 μm on average.

In order to counteract a possible trickling out of the particle material after the attachment on the tip if the apparatus is held upright, there may be provided that the shaft tapers away from the tip in the portion adjacent to the tip, so that an inclined face is available in the region of the transverse hole which forms a kind of “undercut”, so that in this position hardly any particle material may get via the hole into the interior of the suction tube body unless suction is performed. Moreover, a plurality of relatively small transverse holes may also be provided to prevent trickling out.

For a good retention of the capsule on the shaft it is, on the other hand, expedient if the shaft is of cylindrical design at least in the portion facing the suction tube body. On this cylindrical portion of the shaft the respective capsule is retained frictionally with the opening portion after the piercing or the applying of the opening in the capsule wall, respectively, wherein the entry of air between the shaft portion and the opening wall of the capsule is ensured nevertheless.

In order to avoid an excessive attachment of the capsule on the tip and the shaft, it is of advantage if the shaft is confined by at least one capsule abutment element at the end facing away from the tip. The capsule abutment element may have a curved front face, wherein in particular a cylindrical or else a partly spherical curvature may be present. In the case of such a design of the capsule abutment element, a safe rest of the capsule on the abutment element is ensured even if the capsule is attached and pierced in an inclined manner.

On the other hand, in view of a particularly simple design it may also be favourable if the capsule abutment element has a plane front face. It is further favourable for easy manufacturing if the capsule abutment element is formed at the suction tube body by a disc member having the plane front face.

In order to avoid members that project or protrude in an interfering manner, there may advantageously also be provided that the cross-section of the suction tube body widens continuously toward the capsule abutment element until it has the same contour.

For a palatable design and a comfortable use, the suction tube body may further be thickened at the suction end to form a mouth piece. Furthermore, the suction channel may be widened toward the suction end so as to achieve an expansion of the suction jet immediately before it is supplied to the mouth.

The suction tube body may have a relatively small cross-section so as not to require a too large wall thickness with a given cross-section of the suction channel resulting with a view to the amount of particle material to be taken in. In order to facilitate the seizing of the apparatus by increasing the cross-section, there is preferably further provided that the suction tube body is assigned with a sleeve adapted to be slid thereon or having been slid thereon, respectively. This sleeve may consist of paper or of plastics, with a certain stiffness being expedient.

In order to prevent the trickling out of particle material through the suction tube body when the apparatus is not being used, a valve may advantageously also be assigned to the suction channel, said valve opening during sucking and thus enabling the passage of the air flow along with the particle material. This valve may be provided in the suction tube body itself, in the interior of the suction channel, but it is also possible to arrange such a valve in the region of the transverse hole in the shaft of the apparatus. This valve may expediently be designed as a diaphragm valve implementing a kind of check valve or suction valve (differential pressure valve).

In a particularly simple embodiment of the present apparatus, the shaft and the tip are arranged coaxially to the suction tube body, i.e. they have a joint longitudinal axis, so that altogether a cigarette-like appearance is achieved if the suction tube body extends straightly.

It is, however, also favourable if the axes of the shaft and the tip are arranged at an angle, e.g. at a right angle, to the suction tube body. In this design in the manner of a pipe, with a capsule standing upright at the suction tube body, the particle material or powder advantageously always rests on the bottom of the capsule, so that during sucking particle material is always safely available or the maximum amount of particle material is available in the region of the hole or of the holes. This may also be achieved in a corresponding manner if the suction tube body has a progression that is curved like a pipe. The suction tube body may have single or double curves, wherein the shaft with the tip may either be arranged in line with the adjacent region of the suction tube body or else, similar to the preceding embodiment, may be arranged e.g. at right angles thereto.

In order to prevent an unintended loosening of a capsule attached to the tip of the suction tube body, it is further of advantage if the shaft, at the side of the hole positioned closer to the suction end, comprises at least one retention projection, e.g. in the form of an annular bead, for an attached capsule. The retention projection or the annular bead, respectively, prevents in the kind of a barbed hook that the attached capsule slides off the tip of the suction tube body, i.e. the piercing device. The capsule will then abut on the retention projection with its inwardly bent perforation edge and, if there is also provided an abutment element, will expediently be retained with this perforation edge between the abutment element and the retention projection (bead).

Another advantageous embodiment of the present apparatus is characterized in that the suction tube body comprises, in the region of the suction end, at least one profiling, e.g. profilings in the form of ribs or grooves, so as to facilitate the holding of the suction tube body with the lips or teeth, respectively. The profilings provided at the suction or mouth piece end, for instance, in the form of parallel retention ribs, enable an improved holding of the suction tube body and hence of the apparatus between the lips and/or in particular between the incisors. These profilings or ribs, respectively, may also serve as three-dimensional “markings” or as an orientation aid, respectively, for the lips so that they and hence the suction tube body are positioned and retained in a correct orientation so as to ensure the optimum functioning of the apparatus. The ribs or grooves may be provided arcuately at the circumference of the suction tube body, they may also be provided annularly, and there may exist ribs projecting over the circumferential face of the suction tube body as well as simple recesses in the circumferential face in the kind of fillets.

The invention further also relates to a capsule that is particularly suited to be used with such an apparatus, comprising a generally cylindrical capsule body having curved front faces at the ends thereof. This capsule is intended to facilitate piercing with a view to the fact that only one side is pierced in the course of a manipulation by hand. To this end, there is provided that a guiding or attenuating point facilitating a perforation by means of the tip is provided in the middle of at least one front face. Preferably, the guiding or attenuating point is formed by a recess such as a dent. Additionally or instead, there may also be provided that a material thinning exists at the position of the capsule wall to be pierced, so as to facilitate the piercing of the capsule.

The invention will be explained further in the following by means of particularly preferred embodiments illustrated in the drawings, to which it is, however, not intended to be restricted. The drawings show in detail:

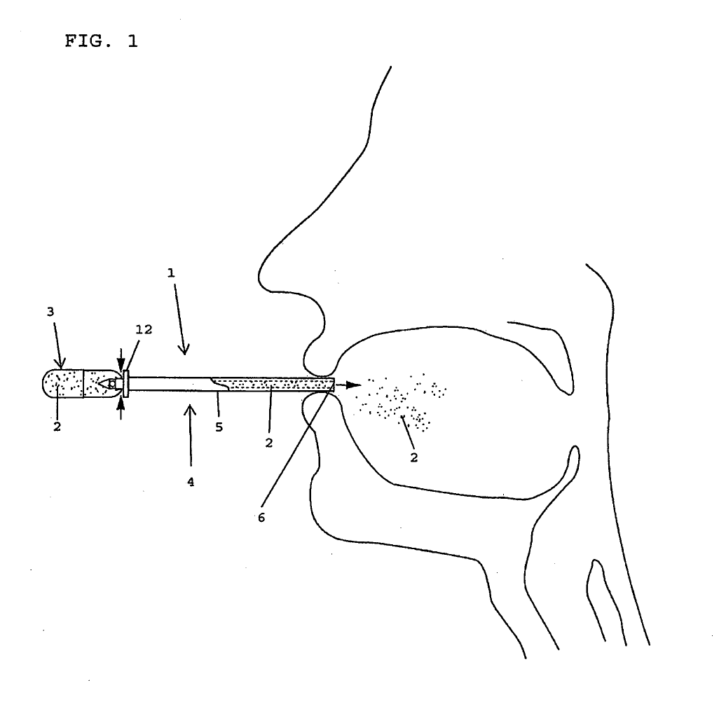

FIG. 1 a schematic view of an apparatus according to the invention during use, wherein the apparatus is illustrated partially in section;

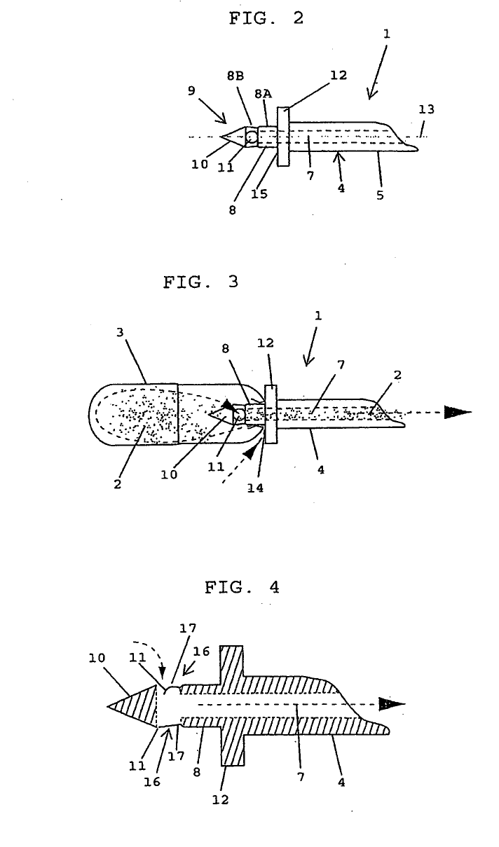

FIG. 2 the region of the piercing end of this apparatus in a scale that is somewhat larger than that of FIG. 1;

FIG. 3 this front region of the apparatus along with the attached capsule during use, wherein the directions of flow are illustrated by arrows;

FIG. 4 a very schematic sectional view of the front end of such an apparatus with a modification to the extent that an elastic diaphragm is provided for forming a valve at the hole in the region of the shaft of the apparatus;

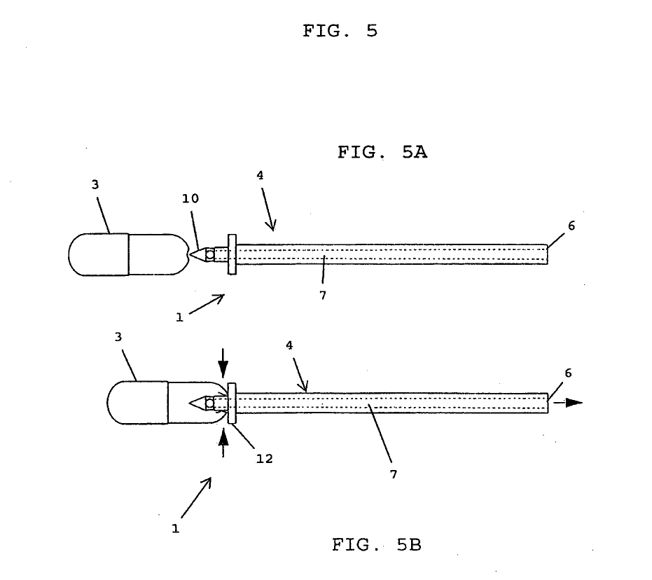

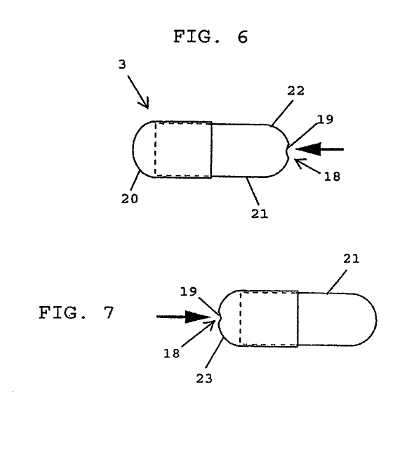

FIG. 5 in the partial FIGS. 5A and 5B, schematic views of an apparatus having a design modified with respect to that of FIG. 1, wherein the suction channel widens toward the suction end, namely pursuant to FIG. 5A in a position immediately prior to the piercing of a capsule, and in FIG. 5B in operation, with the capsule attached;

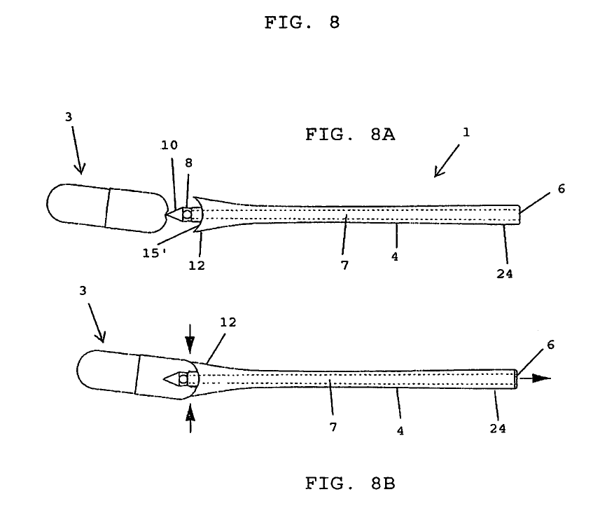

FIGS. 6 and 7 two embodiments of capsules with dent-shaped recesses provided as guiding or attenuating points facilitating piercing;

FIG. 8 in the partial FIGS. 8A and 8B, in illustrations similar to those of FIGS. 5A and 5B, a modified embodiment of the apparatus according to the invention immediately prior to the piercing of a capsule (FIG. 8A) and with an attached, pierced capsule (FIG. 8B);

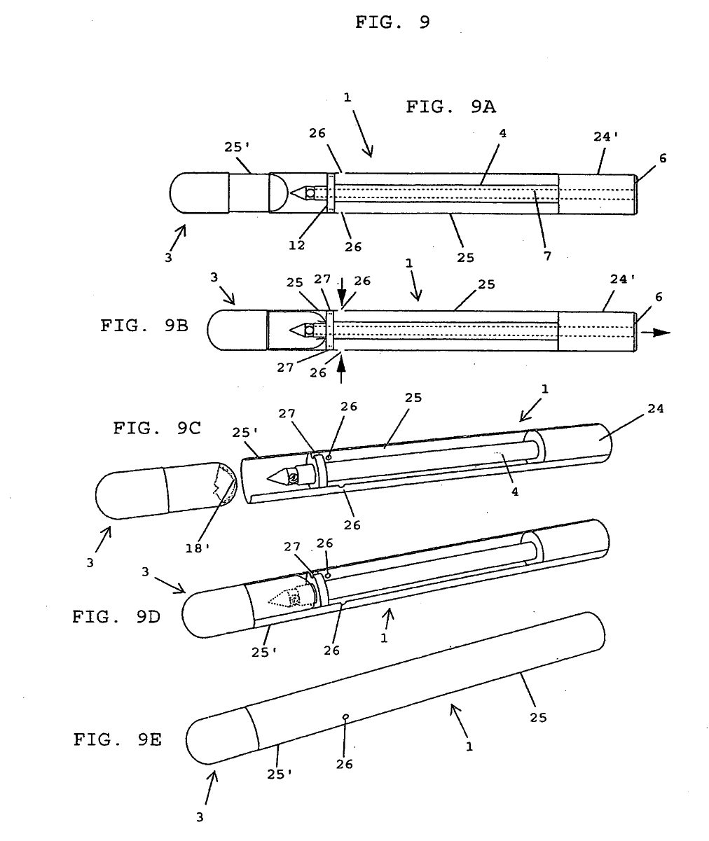

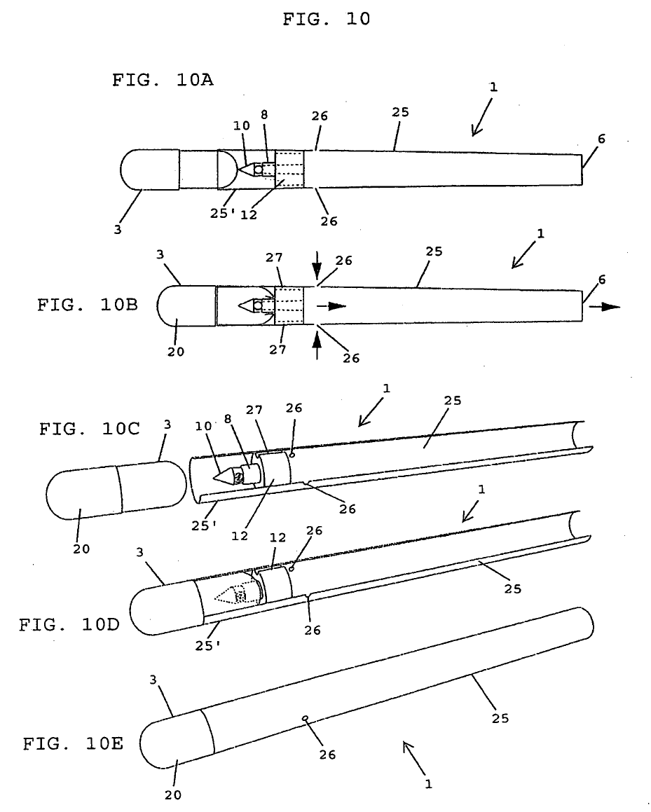

FIG. 9 in the partial FIGS. 9A and 9B, in comparable illustrations a further modified embodiment of the apparatus according to the invention prior to the piercing (FIG. 9A) and after the piercing (FIG. 9B) of a capsule, and in the partial FIGS. 9C and 9D, diagrammatic, partially sectioned illustrations of this modified apparatus belonging to FIGS. 9A and 9B; and the partial FIG. 9E a diagrammatic view of the apparatus pursuant to FIGS. 9A and 9B with attached capsule (cf. in particular FIGS. 9B and 9D);

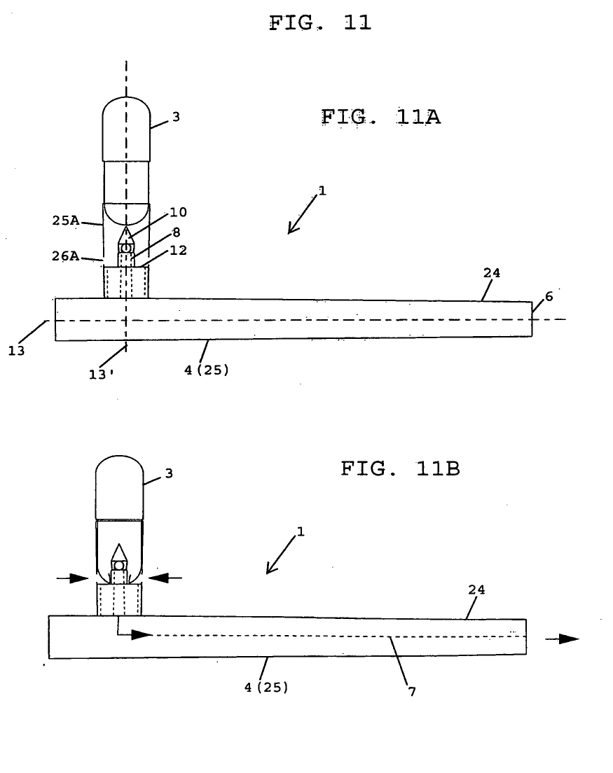

FIG. 10 in the partial FIGS. 10A to 10E, in illustrations comparable to FIGS. 9A to 9E, another embodiment of the apparatus according to the invention;

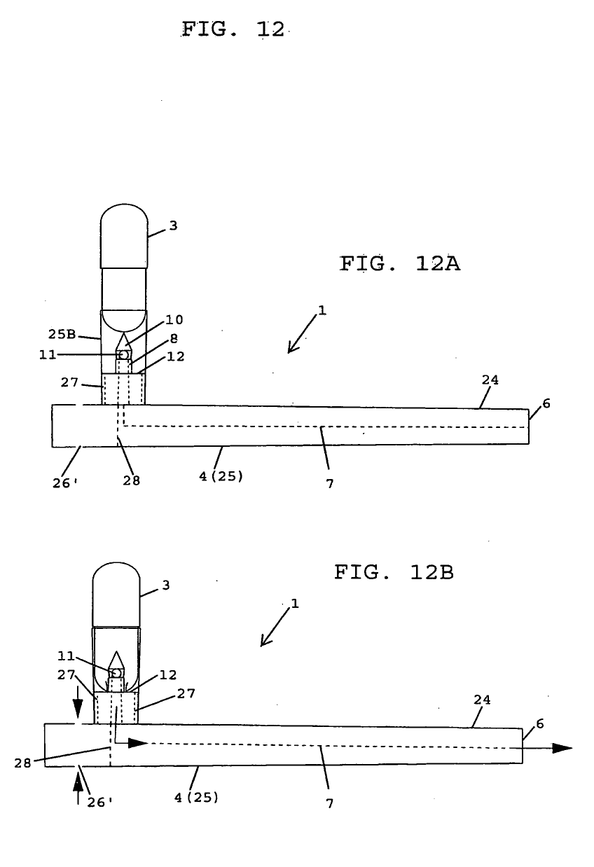

FIG. 11 in the partial FIGS. 11A and 11B, in illustrations comparable to those of FIGS. 5A and 5B, another pipe-like embodiment of the present apparatus, wherein in the illustration of FIG. 11A the capsule is being attached, and in FIG. 11B the operation is indicated by air flow arrows;

FIG. 12 in the partial FIGS. 12A and 12B, in illustrations similar to those of FIGS. 11A and 11B, a modified embodiment, wherein air inlets are provided which are on principle similar to those of FIGS. 9A to 9E or 10A to 10E, respectively;

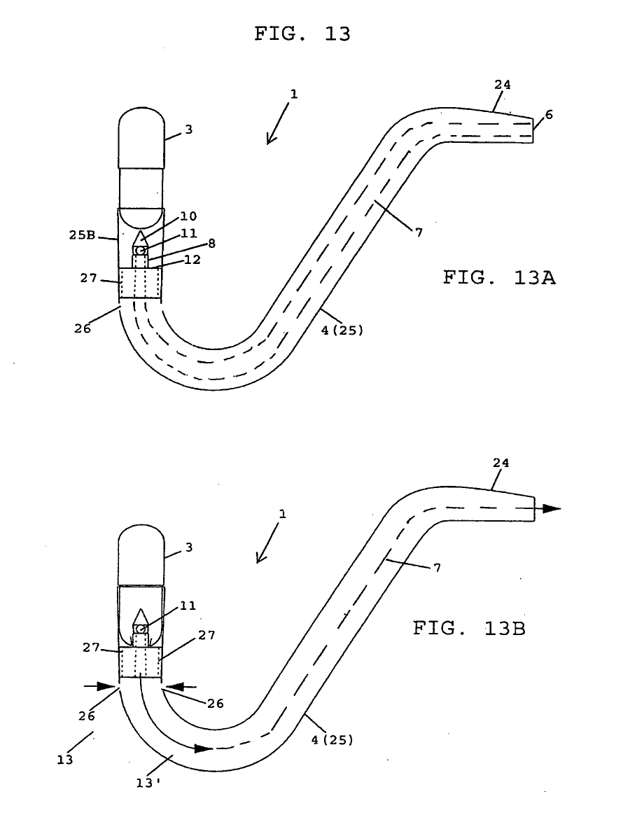

FIG. 13 in the partial FIGS. 13A and 13B, another pipe-like embodiment of the apparatus according to the invention, now however—different from FIGS. 11A/11B or 12A/12B, respectively—with a double-curved suction tube body;

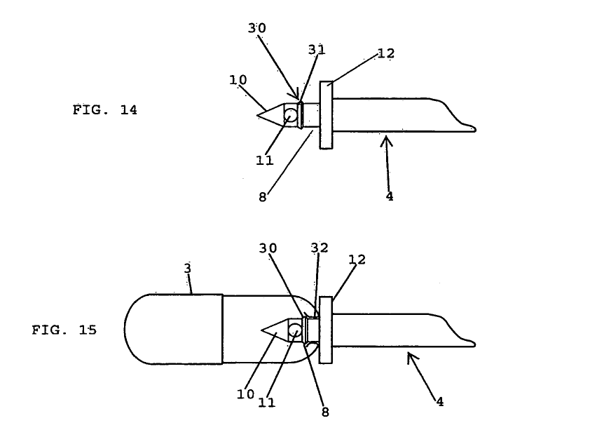

FIGS. 14 and 15 in partial views similar to FIGS. 2 and 3, an embodiment of the apparatus according to the invention in the region of the attachment end, wherein now, as compared to FIG. 2 and/or FIG. 3, a retention projection for an attached capsule is additionally provided in the region of the hole at the attachment end;

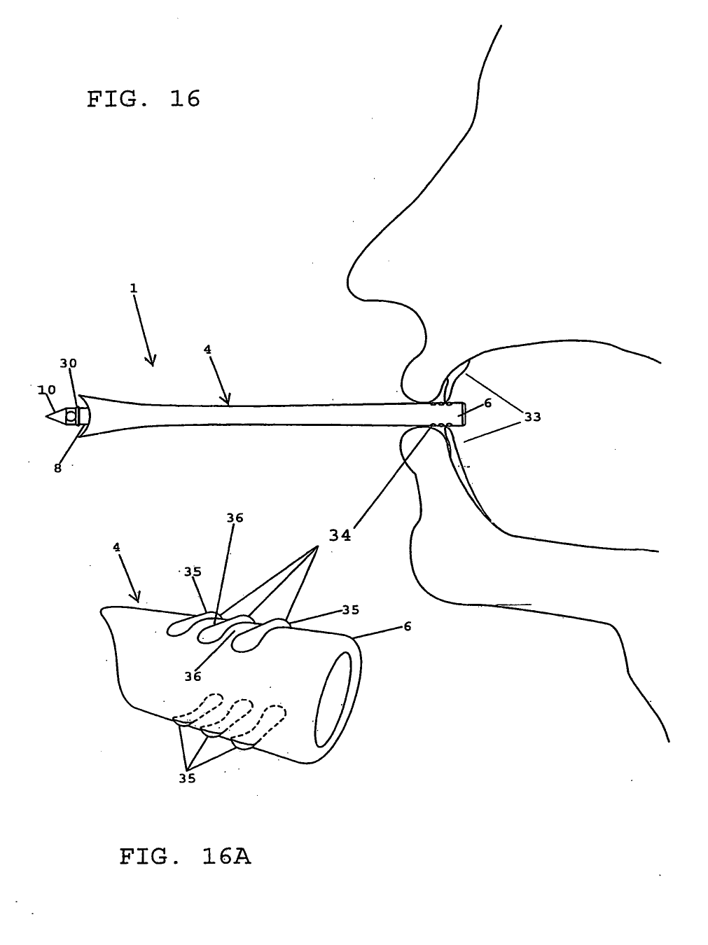

FIG. 16 an embodiment similar to that of FIG. 8, wherein moreover rib-shaped profilings for the improved holding between the incisors are provided at the suction or mouth piece end of the suction tube body; and

FIG. 16A a schematic detailed illustration of the suction tube end of the suction tube body of FIG. 16 in an enlarged scale, for the clearer illustration of the rib-shaped profilings.

FIGS. 1 to 3 illustrate an apparatus 1 for taking in powder material or granules, in the following shortly referred to as particle material 2, from a capsule 3 in accordance with a first embodiment. The apparatus 1 comprises a suction tube body 4 that is here in the form of a hollow pin 5 having a substantially cylindrical shape and being taken into the mouth at a suction end 6 thereof during the use of the apparatus 1, as is illustrated in FIG. 1. A suction channel 7 extends within the interior of the suction tube body 4 or the hollow pin 5, respectively, so as to enable the intake of the particle material 2 from the capsule 3 after the piercing and attaching thereof to the apparatus 1, as illustrated in FIGS. 1 and 3.

At the end of the suction tube body 4 opposite of the suction end 6, the suction tube body transitions, via a shaft 8 comprising a cylindrical portion 8A and a frustoconical portion 8B, into a conical tip 10 provided as a piercing device 9. In the frustoconical portion 8B of the shaft 8 which tapers away from the tip 10 to the rest of the suction tube body 4, a radially or transversely extending hole 11 is provided which is in communication with the suction channel 7 of the suction tube body 4.

The shaft 8 is confined to the rear, i.e. to the suction tube body 4, by an abutment element 12, wherein this abutment element 12 serves as an abutment for the attachment of the capsule 3, see FIGS. 1 and 3.

The suction tube body 4 or hollow pin 5, respectively, extends in this embodiment along a common longitudinal axis 13 illustrated with a dot-dashed line in FIG. 2 and simultaneously being the (longitudinal) axis of the shaft 8 and the tip 10.

As may in particular be seen from FIGS. 1 and 3, during the use of the apparatus 1, a respective capsule 3 is pierced at one side only by being attached to the tip 10 and the shaft 8 until it rests on the abutment element 12. In so doing, an opening 14 is pierced or cut at one front end of the capsule 3, wherein the opening edges may bend inwardly, as illustrated in FIG. 3. As is further illustrated with arrows in FIGS. 1 and 3, air may, on the one hand, flow through this opening 14, in the form of a gap between the opening edge of the capsule 3 and the shaft 8, in a restricted flow rate, wherein it is swirled in the interior of the capsule 3 and also swirls the particle material 2. The flow of penetrated air and particle material then enters, on sucking at the suction end 6 (FIG. 1), through the hole 11 into the suction channel 7, so that the particle material 2 is, in accordance with FIG. 1, transported into the mouth cavity and absorbed there, for instance, via the buccal mucosa.

By means of the “inclination” of the portion 8B with the transverse hole 11 in the manner of an undercut, the trickling out of the particle material 2 is counteracted if the capsule 3 is held upwards.

The tip 10 has a cone vertex angle adapted to the material of the capsules, wherein it is the more acute-angled, the more brittle the material is, and may be the shorter, the softer the material of the capsule wall is. The attached capsule 3 is retained frictionally at the shaft 8 which is therefore, in its portion 8A (see FIG. 2) adjacent to the actual suction tube body 4, preferably designed cylindrically, wherein the breaking edge of the opening 14 closes the shaft 8 without the entry of air being blocked completely. The abutment element 12 prevents the capsule 3 from being shifted excessively onto the apparatus 1. In the embodiment pursuant to FIGS. 1 to 3, this abutment element 12 has a plane front face 15 for the capsule 3 to rest thereon, wherein the abutment element 12 is designed in the form of a cylindrical disc.

In the embodiment pursuant to FIG. 4—which corresponds substantially to that of FIGS. 1 to 3—an elastic diaphragm 17 is arranged in the region of the transversely running suction hole 11 as a valve 16 acting as a suction valve (check or differential pressure valve) so as to release the hole 11 during the sucking through the suction channel 7 in order to have the sucked air flow with the particle material penetrate pursuant to the arrow indicated in dashes in FIG. 4. FIG. 4 further illustrates that several transverse holes 11, e.g. two diametrically opposing holes 11, may also be provided. Embodiments with three or four holes 11 are, of course, also possible. In the illustration in FIG. 4, the diaphragm 17 or the valve 16, respectively, at the bottom of the apparatus is shown in the closed position, whereas the diaphragm 17 at the top is illustrated in the open position. The valve 16 or the diaphragm 17, respectively, prevents the particle material from trickling out if the capsule is attached. Once a suction flow is initiated, the valve 16, i.e. the elastic diaphragm 17, however opens inwardly and hence enables the desired function of transport of the particle material in the air flow toward the mouth of the user.

The embodiment of the apparatus 1 pursuant to FIGS. 5A and 5B corresponds substantially to that of FIGS. 1 to 3, wherein the difference that is provided merely is that the suction channel 7 continuously widens in the interior of the suction tube body 4 toward the suction end 6. Thus, also the particle material jet is expanded during the entering of the mouth cavity so as to favourably distribute the particle material across the mouth cavity.

Apart from that, the embodiment pursuant to FIGS. 5A and 5B corresponds to that of FIGS. 1 to 3, so that a another detailed description is unnecessary.

FIGS. 6 and 7 show two embodiments of a capsule 3 provided with a guiding or attenuating point 18 in the form of a dent-shaped recess 19 to facilitate piercing. In both cases, the capsule 3 consists of two capsule halves 20, 21, as this is per se known, wherein these two capsule halves 20, 21, after being filled with the particle material 2 that is not shown in FIGS. 6 and 7, are telescoped, wherein either a snug fit is given or a subsequent glue connection is provided. In the case of FIG. 6, the recess 19 is positioned at the partially spherical front face 22 of the capsule half 21 having a smaller cross-section, whereas in the embodiment of FIG. 7 the larger capsule half 20 forming a cap is provided with the recess 19 at the curved front side 23 thereof.

This way it is possible, as is indicated schematically with an arrow in FIGS. 6 and 7, to pierce the respective capsule 3 straight to the point with the tip 10 of the apparatus 1, wherein, as mentioned, the piercing at one side is sufficient to successively empty the capsule 3 by means of the present apparatus 1 by dosed sucking.

The recess as a guiding means or else a weakening means may result in a thinning point, i.e. in a material thinning of the capsule wall at the position 18. It is also possible to simply provide a material thinning without a guiding recess at the crown of the respective curved front wall 22 or 23, as is illustrated schematically in FIG. 9C with 18′.

In FIGS. 8A and 8B, another modification of the present apparatus 1 for taking in particle material from a capsule 3 attached to the tip 10 and the shaft 8 is illustrated, wherein in FIG. 8A the phase of the piercing of the capsule 3 and of the attaching of same and in FIG. 8B the completely attached capsule 3 are shown again. The tip 10 and the shaft 8 again correspond in their design to that of FIGS. 1 to 3 or FIGS. 5A and 5B, so that it is unnecessary to explain them again. Furthermore, in the embodiment pursuant to FIGS. 8A and 8B the suction channel 7 is widened toward the suction end 6, similar as with the embodiment pursuant to FIGS. 5A and 5B. In accordance with FIGS. 8A and 8B, the outer diameter of the suction tube body 4 correspondingly widens toward the suction end 6, so that an outer shape of the suction tube body 4 is obtained which slightly tapers from the rear suction end 6 toward the front tip. The suction tube body 4 widens, however, in the last portion before the shaft 8 and the tip 10 (for instance, conically) toward the abutment element 12 for the capsule 3. Furthermore, a curved front face 15′ is provided here as a front face of the abutment element 12, in contrast to the plane front face 15 in the case of the abutment element 12 pursuant to FIG. 1 to FIG. 3. This curved front face 15′ may, for instance, be curved partially spherically or else partially cylindrically. This way, it is possible to attach the capsule 3, except coaxially to the suction tube body 4, also in an inclined manner relative to the latter, as may be gathered from FIG. 8A and in particular from FIG. 8B, wherein a good abutment on the front face 15′ of the abutment element 12 is nevertheless ensured. This embodiment is particularly suited for an uncontrolled attachment of the capsule 3, although the capsule 3 may of course also comprise a recess 19 or a guiding/weakening point 18 (see FIGS. 6 and 7) in this case.

Here, too, the apparatus 1, i.e. the suction tube body 4 along with the abutment element 12, the shaft 8, and the tip 10, may be manufactured integrally. By the thickening of the suction tube body 4 toward the suction end 6, a mouth piece 24 is obtained at this suction end 6. Furthermore, the widening of the suction channel 7 toward the suction end 6 minimizes the sticking together of the sucked material by saliva flowing in at the suction end 6.

In the embodiment of the apparatus 1 pursuant to FIGS. 9A to 9E there is provided, in addition to the suction tube body 4—which may, for instance, be designed as illustrated in FIGS. 1 to 3 (or in FIGS. 5A and 5B or else in FIGS. 8A, 8B)—, an outer shell or sleeve 25 that rests frictionally on the mouth-side end of the suction tube body 4—that is thickened to a mouth piece 24 there—in a mouth piece region 24′ and is in close abutment at the front side at the outside of the abutment element 12. This shell 25 extends beyond the front of this abutment element 12, so that it forms a guide 25′ for the respective capsule 3 when it is pierced and attached, as is illustrated in particular in FIGS. 9A and 9B or 9C and 9D, respectively. The shell 25 that is illustrated in a sectional view in FIGS. 9C and 9D comprises, for instance, two air inlets 26 directly behind the abutment element 12, and adjacent to these air inlets 26 the abutment element 12 comprises at the outer circumference thereof e.g. axially parallel air channels 27 so as to have air flow to the attachment region of the capsule 3 from the environment if the mouth piece 24 or 24′, respectively, is sucked on. This air flowing in through the air inlets 26 and the air channels 27 in turn gets through the gap between the shaft 8 and the edge of the pierced opening of the capsule 3 into the interior of the capsule to swirl the particle material there and to enable the intake thereof through the suction channel 7, as was explained above by means of FIGS. 1 and 3 in particular.

By the fact that the shell 25 forms in the front region thereof a guide 25′ for the capsule 3 during the attachment thereof, a special guiding or weakening point 18 at the capsule 3 is not required here. If wished, however, a material thinning 18′ may be provided at a middle point at the front side of the capsule 3 so as to facilitate the piercing itself, cf. FIG. 9C.

The shell or outer sleeve 25 may consist of a very simple material, such as e.g. paper. A particular advantage of this embodiment is that the suction resistance may be controlled by the aperture cross-section of the air inlets 26 and the air channels 27 so as to additionally enable a dosing aid during the intake of particle material 2 from the interior of the capsule 3.

In FIGS. 10A to 10E, in illustrations comparable to the illustrations of FIGS. 9A to 9E, an embodiment that has been further modified vis-á-vis these illustrations is shown, wherein now the shell 25 itself forms the suction tube body and only a capsule abutment element 12 along with the shaft 8 and the tip 10 is available as a functioning member in the interior of the shell 25. In this embodiment, the shell 25 is manufactured of a relatively inherently stable, supporting plastic material, similar to a drinking straw, and it may, apart from a possible cylindrical shape, similar to FIGS. 9A to 9E, also taper conically toward the suction end 6. Nevertheless, the front guide member 25′ for the capsule 3 should be cylindrical for the piercing of the capsule 3 and the attachment thereof to the shaft. The front side of the shell 25 may, like in the case of the embodiment of FIGS. 9A to 9E, with the capsule 3 attached, also rest on the boundary between the two capsule halves, namely on the front side of the outer, cap-like capsule half 20, as may be gathered from FIGS. 10B, 10D, and 10E (or 9B, 9D, 9E, respectively).

In FIG. 11 (and similarly in FIGS. 12 and 13) an apparatus 1 is shown which is modified vis-á-vis the previous embodiments to such an extent that, instead of a cigarette or cigar-like appearance with a coaxial arrangement of a straight suction tube body and a shaft with a tip, a pipe-shaped design is provided. In the embodiments pursuant to FIGS. 11A/lib and 12A/12B, a design with a straight suction tube body 4 (or 25, as may be gathered from FIGS. 10A to 10E or FIGS. 9A to 9E) exists, said suction tube body 4 extending straightly, similar to a cigarette holder, but comprising an angular, for instance, rectangular joint for the shaft 8, the tip 10, and hence the capsule 3. In other words, the shaft 8, the tip 10, and the capsule 3 define an axis 13′ (see FIG. 11A) running at an angle, in particular a right angle, to the longitudinal axis 13 of the suction tube body. Along this longitudinal axis 13 of the suction tube body 4, the suction channel 7 also extends in the suction tube body, said suction channel 7 being indicated only schematically with a dashed line in FIGS. 11B, 12A, and 12B.

Similar to the embodiment pursuant to FIGS. 9A to 9E, the embodiments pursuant to FIGS. 11A, 11B, and 12A, 12B provide a generally disc-shaped abutment element 12 for the capsule 3, said abutment element 12, however, being positioned laterally at the suction tube body 4 or 25, respectively, and being adjoined by the shaft 8 with the tip 10. Apart from that, the design of this region in which the capsule 3 is attached corresponds to the previously described embodiments, so that a further explanation is unnecessary. In the context with the embodiment pursuant to FIGS. 11A and 11B there has still to be mentioned that a guide member 25A adjoins the abutment element 12, wherein this guide member 25A guides the capsule 3 during piercing, so that the capsule 3 in the final position pursuant to FIG. 11B may assume a predetermined position in orientation to the axis 13′, similar as described before by means of FIGS. 9A to 9E or 10A to 10E, respectively. The guide member 25A in the embodiment pursuant to FIGS. 11A and 11B comprises lateral air inlets 26A so as to enable during sucking, cf. FIG. 11B, the entry of air into the region where the capsule 3 has been pierced. To this extent, the function of this embodiment corresponds to that of the embodiments pursuant to FIGS. 1 to 8A/8B.

In contrast to this, the embodiment pursuant to FIGS. 12A and 12B comprises a closed guide member 25B for the capsule 3 for piercing on the tip 10. Similar to the embodiment pursuant to FIGS. 9A to 9E or 10A to 10E, respectively, air is here supplied via air channels 27 in the abutment element 12 into the region of the pierced capsule end, wherein this air may enter through air inlets 26′ in the suction tube body 4 or 25, respectively, namely viewed from the suction end 6 on the other side of the abutment element 12, cf. in particular FIG. 12B with the air flows illustrated there again by means of arrows.

Depending on the design of the suction channel 7 in the suction tube body 4 or 25, respectively, in case a simple suction tube body similar to that pursuant to FIGS. 5A and 5B, for instance, should be given, there can be available, at the end of the suction channel 7 adjacent to the joint to the abutment element 12, a transverse wall—illustrated only very schematically with a dashed line in FIGS. 12A and 12B—so as to prevent an air flow bypass. In the embodiment pursuant to FIGS. 11A and 11B, the suction tube body 4 or 25, respectively, would have to be closed correspondingly at the end opposite of the suction end 6.

In FIGS. 13A and 13B, an apparatus 1 with a double-curved suction tube body 4 or 25, respectively, is illustrated. The joint of the capsule holder with the shaft 8 and the tip 10 as well as the abutment element 12 is provided in principle similar to that illustrated in FIGS. 9A to 9E, wherein air inlets 26 and air channels 27 are also provided correspondingly so as to supply air in the region of the pierced capsule end and to have it enter into the interior of the capsule, as already explained above. The capsule guide member is here—similar to FIG. 12A—designated with 25B and corresponds with respect to its design and function substantially to the guide member 25′ of FIGS. 9A to 9E.

In modification of the double-curved suction tube body shape pursuant to FIGS. 13A and 13B, the arc adjacent to the capsule holder might also be omitted, so that, for instance, a substantially—in the position of use—horizontal suction tube body piece is available there, to which the capsule holder with the abutment element 12, the shaft 8, and the tip 10 as well as a guide member 25A or 25B, similar as illustrated in FIGS. 11A/11B or 12A/12B, respectively, may then be joined.

In FIG. 14, the piercing region of a suction tube body 4 is shown in an illustration similar to FIG. 2, wherein again the shaft with the hole 11 as well as the tip 10 and furthermore an abutment element 12 are illustrated. In the embodiment pursuant to FIG. 14, adjacent to the hole 11 there is additionally provided a retention projection 30 at the shaft 8, in particular formed integrally therewith, wherein in the illustrated embodiment this retention projection 30 is simply formed by an annular bead 31 at the shaft 8. This projection 30 or annular bead 31, respectively, between the suction hole 11 and the abutment element 12 spares a section of the shaft 8 adjoining the abutment element 12, where, as may be seen from FIG. 15, a capsule 3, after being pierced and attached to the tip 10 and the shaft 8, rests with its perforation edge 32. The perforation edge 32 is retained between the retention projection 30 and the abutment element 12, and the retention projection 30 serves as a locking means for the capsule 3, wherein it prevents, like a barbed hook, that the attached capsule 3 unintentionally slides off the tip 10 and/or the shaft 8.

As a matter of fact, a projection 30 that does not extend over the entire circumference of the shaft 8 may also be available, such as, for instance, a “divided” projection 30 of discontinuous arc pieces extending over the circumference of the shaft 8, so as to fulfil the desired locking function.

FIG. 16 further shows an embodiment of the present apparatus 1 similar to that of FIG. 8 which—apart from the retention projection 30 at the piercing end as just described—is designed with profilings 34 in the region of the suction end 6 of the suction tube body 4, said profilings favouring a retention of the apparatus 1 between the incisors 33 of a user. These profilings 34 may, for instance, be shaped in the form of arc-shaped ribs 35 having recesses 36 for the incisors 33 in-between. Instead of these recesses or “grooves” 36 confined by the ribs 35, fillet-like grooves may be provided in the suction tube body 4 in a deepened arrangement, so as to correspondingly enable the improved retention of the apparatus 1 with the teeth.

The profilings 34, i.e. the ribs 35 or grooves 36, respectively, may be provided, as illustrated in an arcuate manner, only over part of the circumference of the suction tube body 4, preferably in an opposing orientation, as well as in a continuous annular form.

It is to be understood that, although the apparatus 1 according to the invention was explained above by means of particularly preferred embodiments, further variations and modifications are possible within the scope of the invention. Thus, in the embodiment pursuant to FIGS. 10A to 10E, the shell 25 may be continuously cylindrical, it may, however, also taper only in the last portion adjacent to the suction end 6 or, as the case may be, possibly also widen, so as to obtain a mouth piece with an appropriate cross-section. In the embodiment pursuant to FIGS. 9A to 9E, the suction tube body 4 may be designed in correspondence with that of FIGS. 8A and 8B. In all embodiments it is furthermore possible to provide a valve 16 as explained by means of FIG. 4, wherein a comparable suction valve may also be provided in the interior of the suction tube body 4; and/or to provide a retention projection 30 as described by means of FIGS. 14 and 15; and/or to provide retention profilings 34 as explained by means of FIGS. 16 and 16A. Furthermore, it is also possible to provide, in a mixed form of the embodiments of FIGS. 11A/11B (or 12A/12B) and FIGS. 13A/13B, a substantially straight suction tube body 4 or 25, respectively, away from the mouth piece 24, said suction tube body transitioning into an upwardly directed capsule holder pursuant to FIGS. 13A, 13B at an end opposite of the suction end 6, for instance, by means of a quadrant arc. At any rate, all the embodiments have the common basic principle that in use a capsule is opened at one side only, and that air may penetrate into the interior of the capsule between the broken opening edge of the capsule and the shaft during sucking, that the air is swirled in the interior of the capsule, and that it may finally be taken in through the transverse holes and through the interior of the shaft as well as the suction channel.

1. An apparatus (1) for taking in powder material or granules (2) from a capsule (3), having a suction tube body (4, 25) which comprises a suction channel (7) and a suction end (6), and a capsule holder disposed at the suction tube body (4, 25) opposite of the suction end (6), and a capsule piercing device (9), wherein a capsule piercing tip (10) designed for piercing the capsule (3) on only one side transitions into the suction tube body (4, 25) by way of a shaft (8), wherein in the shaft (8) at least one hole (11) extending radially to the longitudinal axis of the shaft (8) is provided, with which the suction channel (7) in the suction tube body (4) is connected, and wherein the shaft (8) which during the piercing of a capsule (3) rests in the interior thereof, forms the capsule holder.

2. The apparatus according to claim 1, wherein the shaft (8) tapers in the portion (8B) adjacent to the tip (10) in a direction away from the tip (10).

3. The apparatus according to claim 1, wherein the shaft (8) is designed cylindrically at least in the suction tube body-side portion (8A) thereof.

4. The apparatus according to claim 1, wherein the shaft (8) is confined by at least one capsule abutment element (12) at the end facing away from the tip (10).

5. The apparatus according to claim 4, wherein the capsule abutment element (12) comprises a curved front face (15′).

6. The apparatus according to claim 5, wherein the front face (15′) is curved cylindrically.

7. The apparatus according to claim 4, characterized in that wherein the capsule abutment element (12) comprises a plane front face (15).

8. The apparatus according to claim 4, wherein the cross-section section of the suction tube body (4) continuously widens toward the capsule abutment element (12) until it has reached the contour thereof.

9. The apparatus according to claim 7, wherein the capsule abutment element (12) is formed by a disc portion at the suction tube body (4, 25) which comprises the plane front face (15).

10. The apparatus according to claim 1, wherein the suction tube body (4) is thickened to form a mouth piece (24) at the suction end (6).

11. The apparatus according to claim 1, wherein the suction channel (7) widens toward the suction end (6).

12. The apparatus according to claim 1, wherein a valve (16) opening during intake is assigned to the suction channel (7).

13. The apparatus according to claim 1, wherein the suction tube body (4) is assigned with a shell (25) adapted to be slid thereon.

14. The apparatus according to claim 1, wherein the shaft (8) and the tip (10) are arranged coaxially to the suction tube body (4).

15. The apparatus according to claim 1, wherein the shaft (8) and the tip (10) with their axes (13′) are arranged at an angle, e.g. at a right angle, to the suction tube body (4; 25).

16. The apparatus according to claim 1, wherein the suction tube body (4; 25) has a progression curved like a pipe.

17. The apparatus according to claim 1, wherein the shaft (8) comprises, at the side of the hole (11) which is closer to the suction end (6), at least one retention projection (30), e.g. in the form of an annular bead (31), for an attached capsule.

18. The apparatus according to claim 1, wherein the suction tube body (4) comprises, in the region of the suction end (6), at least one profiling (34), e.g. profilings in the form of ribs (35) or grooves (36), so as to facilitate the holding of the suction tube body (4) with the lips and/or teeth.

19. A capsule (3) for use with an apparatus (1) according to claim 1, comprising a generally cylindrical capsule body having curved front faces (22, 23) at the ends thereof, wherein a guiding or weakening point (18) is provided in the middle of at least one front face (22, 23) which facilitates a perforation by means of the tip (10).

20. The capsule according to claim 19, wherein the guiding or attenuating point (18) is formed by a recess (19).

21. The capsule according to claim 19, wherein the guiding or attenuating point (18) comprises a material thinning (18′) of the capsule wall.
